(19) United States
(12) Patent Application Publication
(10) Pub. No.: US 2025/0386322 A1
(43) Pub. Date: Dec. 18, 2025

(54) SYSTEMS, METHODS, AND DEVICES FOR ENHANCED POSITIONING USING RIS

(71) Applicant: Apple Inc., Cupertino, CA (US)

(72) Inventors: Benedikt SCHWEIZER, Muenchen (DE); Ayman F. NAGUIB, Cupertino, CA (US); Bertram R. GUNZELMANN, Koeningsbrunn (DE)

(21) Appl. No.: 18/745,741

(22) Filed: Jun. 17, 2024

(51) Int. Cl. H04W 64/00; H04B 7/04; H04L 5/00

(52) U.S. Cl. CPC H04W 64/003; H04B 7/04013; H04L 5/0051

(57) ABSTRACT

The techniques herein include solutions for enhanced positioning using RIS. A reference signal can be communicated from one transmission reception point (TRP) to another TRP. Either TRP could be a base station or a UE. The reference signal can also be communicated to one or more reconfigurable intelligent surfaces (RISs). As each RIS can apply a different modulation scheme to the reference signal, the receiving TRP can distinguish between reference signals, as well as determine which reference signal came from which RIS. The positioning can be determined based on the different characteristics of the reference signals, using time-difference-of-arrival (TDoA), round-trip-time (RTT), or another type of positioning procedure. These and many other features and examples are discussed herein.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fourth generation (4G), fifth generation (5G) or new radio (NR) technology. Such technology can include solutions for enabling user equipment (UE) and network devices, such as base stations, to communicate with one another. One of many aspects of developing such technologies can include providing ways to enable the determination of the geographical location of devices.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example process for enhanced positioning using reconfigurable intelligent surface (RIS) according to one or more implementations described herein.

FIG. 4 is a diagram of an example of UE positioning using a one RIS according to one or more implementations described herein.

FIG. 5 is a diagram of an example of resource element (RE) comb-like structures according to one or more implementations described herein.

FIG. 6 is a diagram of an example of UE positioning using multiple RIS according to one or more implementations described herein.

FIG. 7 is diagram of an example of RE comb structures according to one or more implementations described herein.

FIG. 8 is a diagram of an example process for enhanced positioning using RIS according to one or more implementations described herein.

FIG. 9 is a diagram of an example of determining a position of an RIS according to one or more implementations described herein.

FIG. 10 is a diagram of an example of determining a position of an RIS according to one or more implementations described herein.

FIG. 11 is a diagram of an example of a RE comb structure using double-sideband modulation according to one or more implementations described herein.

FIG. 12 is a diagram of an example of a RE comb structure using double-sideband multi-tone modulation according to one or more implementations described herein.

FIG. 13 is a diagram of an example of an arbitrary RE comb structure according to one or more implementations described herein.

FIG. 14 is a diagram of an example of a RE comb structure using a time delay according to one or more implementations described herein.

FIG. 15 is a diagram of an example of REs using a symbol-wise frequency shift according to one or more implementations described herein.

FIG. 16 is a diagram of an example of REs for secure positing with RIS according to one or more implementations described herein.

FIG. 17 is a diagram of an example of UE using RIS separation in a frequency-shift-based code-domain according to one or more implementations described herein.

FIG. 18 is a diagram of examples of RE patterns using RIS separation in a frequency-shift-based code-domain according to one or more implementations described herein.

FIG. 19 is a diagram of an example of components of a device according to one or more implementations described herein.

FIG. 20 is a diagram of example interfaces of baseband circuitry according to one or more implementations described herein.

FIG. 21 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 22 is a diagram of an example process for enhanced positioning using RIS according to one or more implementations described herein.

FIG. 23 is a diagram of an example process for enhanced positioning using RIS according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Telecommunication networks can include user equipment (UEs) capable of communicating with base stations and/or other network access nodes. UEs and base stations can implement various techniques and communications standards for enabling UEs and base stations to discover one another, establish and maintain connectivity, and exchange information in an ongoing manner. Objectives of such techniques can include ensuring that the location of a UE or another device can be accurately and reliable determined.

Device location or positioning procedures can involve one or more types of signals and/or procedures. Examples of such signals can include a sounding reference signal (SRS) and a positioning reference signal (PRS). An SRS can provide channel quality information from the UE to the base station. The information can help the base station optimize transmission parameters and determine a suitable transmission strategy that is adapted to varying channel conditions. The base station can allocate specific time and frequency resources to the UE for SRS. The resources can be configured dynamically based on the network conditions. An SRS can be transmitted over a physical layer using the allocated resources.

A PRS can be used to provide accurate positioning information. The PRS can be used by devices (e.g., a UE, base station, etc.) to determine a location of the device by measuring a time of arrival (ToA) and angle of arrival (AoA) of the PRS. The precision which location is determined can increase when multiple PRSs are received from different transmitting devices as the ToA and AoA of each signal can be compared to one another. The PRS can be used by the UE to perform measurements for positioning. The measurements can be reported back to the network, which can calculate the UE's position using trilateration, triangulation, or another positioning method. PRS can be integrated with other technologies, such as a global navigation satellite system (GNSS) to provide a comprehensive positioning solution that works both indoors and outdoors.

DL time-difference-of-arrival (DL-TDOA) can also be used for determining the position of a device. In DL-TDOA, a UE can receive a PRS from several base stations and calculate a TOA of each PRS signal. The TOA of one base station can be taken as a reference to compute a reference-signal-time-difference (RSTD) to TOAs from the remaining base stations. The UE can send the RSTD measurements to a location management function (LMF) of the core network, to compute the UE position using known geographical coordinates of base stations.

UL time-difference-of-arrival (UL-TDOA) can also be used for determining the position of a device. In UL-TDOA, the UE can transit an SRS that is received by neighboring base stations. A transmission measurement function can calculate the relative-time-of-arrival (RTOA) and send it to the LMF to compute the UE position.

Multi-cell round-trip-time (Multi-RTT) can also be used for determining the position or location of a device. In Multi-RTT, a base station and UE can perform receive (Rx) and transmit (Tx) time difference measurements, using PRS and SRS signaling, for the signal of each cell. An LMF can initiate a procedure whereby multiple base stations and the UE perform the base station Rx-Tx and UE Rx-Tx measurements, respectively. Multi-RTT can have a higher positioning accuracy than TDOA-based methods and relaxes requirements on time synchronization.

Wireless signals between wireless devices (e.g., UEs and/or base stations) can involve a reconfigurable intelligent surface (RIS) (also referred to as a large intelligent surface (LIS), smart reflect-array, intelligent passive mirrors, artificial radio space, reconfigurable metasurface, holographic multiple input multiple output (MIMO), etc.). An RIS can be an array of configurable elements known as metamaterial cells or unit cells. A metamaterial can be a material engineered to change properties in order to manipulate an amplitude and/or a phase of a wave incident on the metamaterial. This can be achieved by changing an impedance or relative permittivity (and/or permeability) of the metamaterial. At lower frequencies, the impedance can be controlled through lumped elements like PIN diodes, varactors, transistors, microelectromechanical system (MEMS), etc. At higher frequencies, the relative permittivity and/or permeability of the material element (e.g., liquid crystal at high frequencies and graphene at even higher frequencies) can change in accordance to changes in a bias voltage provided to the material. Consequently, the phase of the signal redirected by the material is changed in accordance with the change in permittivity. As the bias voltages involved for these materials can be somewhat low, the materials can be often referred to as passive phase shifters.

An RIS (or RIS device) can be described as a set of configurable elements arranged in a linear array or a planar array; however, the techniques described herein, are also applicable to other two or three dimensional arrangements (e.g., a circular array). A linear array can be a vector of N configurable elements and a planar array can be a matrix of N×M configurable elements, where N and M are integer values. The configurable elements can have the ability to redirect a wave/signal that is incident on the linear or planar array by changing the phase of the wave/signal. The configurable elements can also be capable of changing the amplitude, polarization, or frequency of the wave/signal.

In some planar arrays these changes can occur as a result of changing bias voltages that control the individual configurable elements via a control circuit connected to the linear or planar array. The control circuit can be connected to a communications network that base stations and UEs use for communicating. For example, the network that controls the base station can also provide (via a wired or wireless interface) control and configuration information to the linear or planar array. Control methods other than bias voltage control include, but are not limited to, mechanical deformation and phase change materials. Because of an ability to manipulate the incident wave, the low cost, and because RIS devices can use small bias voltages, RIS devices have become of greater interest as an aspect of innovation and implementation.

One or more of the techniques, described herein, provide solutions for enhanced positioning by using RISs in a wireless communications network. A reference signal, such as an SRS or PRS, can be communicated from one transmission reception point (TRP) to another TRP. Either TRP could be a base station or a UE. The reference signal can also be communicated to another TRP via one or more RIS. Knowing the location of the transmitting TRP and the RISs, and also knowing the configuration or signal modulation used by the RISs, the receiving TRP can determine whether reference signal corresponds to which transmitting device and determine a position of the receiving TRP based on difference between the reference signals and locations of the transmitting TRPs (e.g., base station and RISs).

The techniques, described herein, can apply to positioning procedures and reference signals in both the UL and DL directions. As such, techniques described as being performed in a DL direction (e.g., with a reference signal from one or more base stations to a UE) can also be applied to the UL direction (e.g., with a reference signal from a UE to one or more base stations). The positioning can be determined based on the different characteristics of the reference signals, using DL-TDOA, UL-TDOA, multi-RTT, RTT, or another type of positioning procedure. These and many other features and aspects of the techniques described herein are presented below with reference to the Figures.

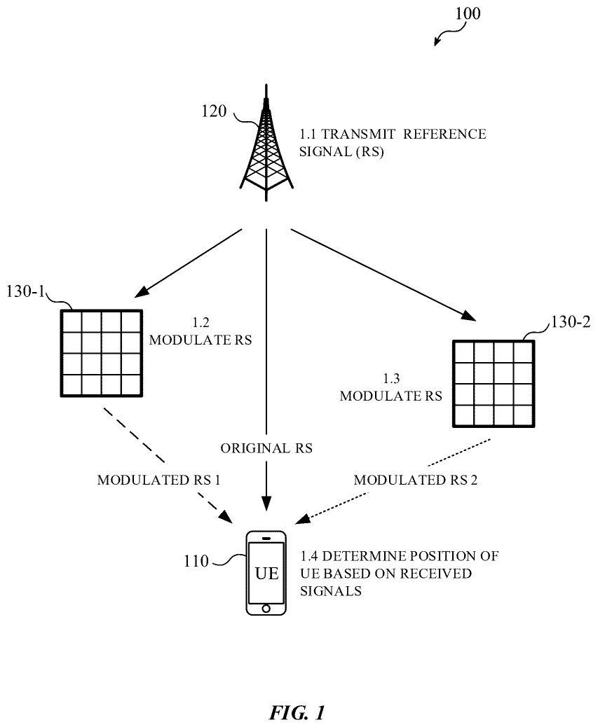

FIG. 1 is a diagram of an example of an overview 100 according to one or more implementations described herein. As shown, overview 100 can include UE 110, base station 120, RIS 130-1 and RIS 130-2. Base station 120 can communicate a reference signal (e.g., a PRS) to UE 110, RIS 130-1 and RIS 130-2 (at 1.1). RIS 130-1 can apply a first modulation scheme to the reference signal to generate modulated RS 1 (at 1.2). RIS 130-2 can apply a second modulation scheme to the reference signal to generate modulated RS 2 (at 1.3). Reference signal from the base station can have a time and frequency resources profile characterized by a comb-like structure of resource element (REs).

Applying the first and second modulation schemes to the reference signal can include a change to the time and frequency resources profile of the reference signal, such that the original reference signal, modulated RS 1, and modulated RS 2 can each have different time and frequency resources profiles. UE 110 can receive the original reference signal from base station 120, modulated RS 1 from RIS 130-1, and modulated RS 2 from RIS 130-2. UE 110 can apply one or more positioning procedures (e.g., a DL-TDOA, RTT, etc.) to the characteristics of the received reference signals to determine a geographic location of UE 110. These and many other features and aspects of the techniques described herein are presented below with reference to remaining Figures.

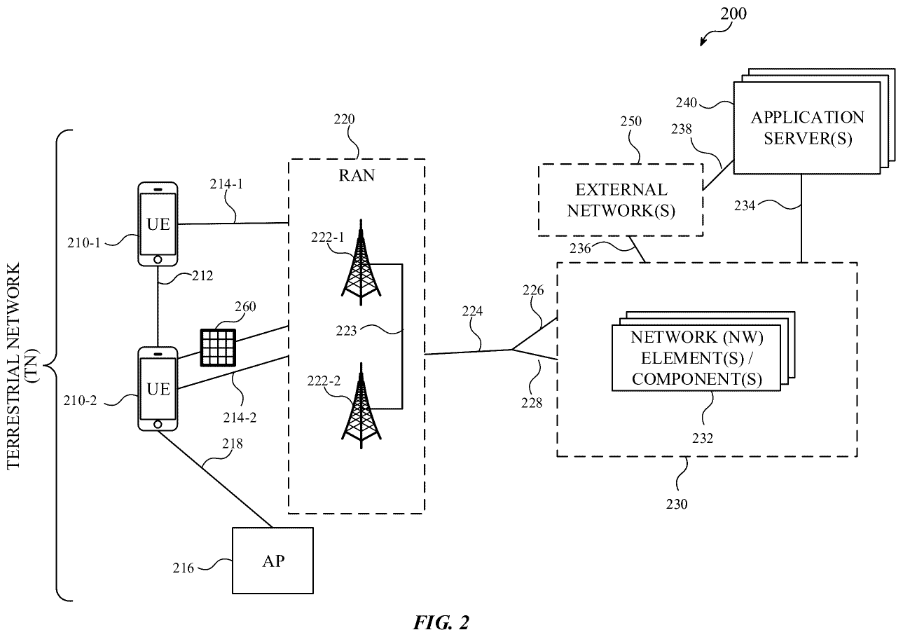

FIG. 2 is an example network 200 according to one or more implementations described herein. Example network 200 can include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node such as a base station. Base station 222 may therefore refer to RAN node 222. In some implementations, discovery, authentication, resource negotiation, registration, etc., can involve communications with RAN node 222 or another type of network node.

UEs 210 can use one or more wireless channels 212 to communicate with one another. As described herein, UE 210 can communicate with RAN node 222 to request SL resources. RAN node 222 can respond to the request by providing UE 210 with a dynamic grant (DG) or configured grant (CG) regarding SL resources. A DG can include a grant based on a grant request from UE 210. A CG can involve a resource grant without a grant request and can be based on a type of service being provided (e.g., services that have strict timing or latency requirements). UE 210 can perform a clear channel assessment (CCA) procedure based on the DG or CG, select SL resources based on the CCA procedure and the DG or CG; and communicate with another UE 210 based on the SL resources. The UE 210 can communicate with RAN node 222 using a licensed frequency band and communicate with the other UE 210 using an unlicensed frequency band.

UEs 210 can communicate and establish a connection with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes (e.g., 222-1 and 222-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of RAN node 222.

As described herein, UE 210 can receive and store one or more configurations, instructions, and/or other information for enabling SL-U communications with quality and priority standards. A PQI can be determined and used to indicate a QoS associated with an SL-U communication (e.g., a channel, data flow, etc.). Similarly, an L1 priority value can be determined and used to indicate a priority of an SL-U transmission, SL-U channel, SL-U data, etc. The PQI and/or L1 priority value can be mapped to a CAPC value, and the PQI, L1 priority, and/or CAPC can indicate SL channel occupancy time (COT) sharing, maximum (MCOT), timing gaps for COT sharing, LBT configuration, traffic and channel priorities, and more.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection 218 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230. In some scenarios, UE 210, RAN 220, and AP 216 can be configured to utilize LTE-WLAN aggregation (LWA) techniques or LTE WLAN radio level integration with IPsec tunnel (LWIP) techniques. LWA can involve UE 210 in RRC_CONNECTED being configured by RAN 220 to utilize radio resources of LTE and WLAN. LWIP can involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling can include encapsulating the entirety of original IP packets and adding a new packet header, thereby protecting the original header of the IP packets.

RAN 220 can include one or more RAN nodes 222-1 and 222-2 (referred to collectively as RAN nodes 222, and individually as RAN node 222, also referred to as base station 222 and base stations 222)) that enable channels 214-1 and 214-2 to be established between UEs 210 and RAN 220. RAN nodes 222 can include network access points configured to provide radio baseband functions for data and/or voice connectivity between users and the network based on one or more of the communication technologies described herein (e.g., 2G, 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 222 to UEs 210, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements (REs). Each resource block can comprise a collection of resource elements; in the frequency domain, this can represent the smallest quantity of resources that currently can be allocated. There are several different physical downlink channels that are conveyed using such resource blocks.

Further, RAN nodes 222 can be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 can operate using stand-alone unlicensed operation, licensed assisted access (LAA), eLAA, and/or feLAA mechanisms. In these implementations, UEs 210 and the RAN nodes 222 can perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations can be performed according to a listen-before-talk (LBT) protocol.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information fed back from any of UEs 210. The downlink resource assignment information can be sent on the PDCCH used for (e.g., assigned to) each of UEs 210.

One or more of the techniques described herein can enable enhanced positioning using RIS 260. RIS 260 can be a device that includes a wired and/or wireless network interface, a controller (that includes a memory, storage device, one or more processors, and other components, that are capable of receiving configuration information and implementing the configuration information. The configuration information can be implemented as a signal modulation scheme that is configured to manage a set of configurable elements arranged in a linear array or a planar array. A linear array can be a vector of N configurable elements and a planar array can be a matrix of N×M configurable elements, where N and M are integer values. The configurable elements can have the ability to redirect a wave or signal that is incident on the linear or planar array by changing the phase of the wave/signal. The configurable elements can also be capable of changing the amplitude, polarization, frequency resources, or time resources of the wave or signal.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface can include an X2 user plane interface (X2-U) and an X2 control plane interface (X2-C). The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN, and/or one or more additional or alternative types of CNs. The components of the CN 230 can be implemented in one physical node or separate physical nodes including components to read and execute instructions from a machine-readable or computer-readable medium (e.g., a non-transitory machine-readable storage medium). In some implementations, network function virtualization (NFV) can be utilized to virtualize any or all the above-described network node roles or functions via executable instructions stored in one or more computer-readable storage mediums (described in further detail below). A logical instantiation of the CN 230 can be referred to as a network slice, and a logical instantiation of a portion of the CN 230 can be referred to as a network sub-slice. Network Function Virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 can also, or alternatively, be configured to support one or more communication services (e.g., voice over IP (VOIP sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

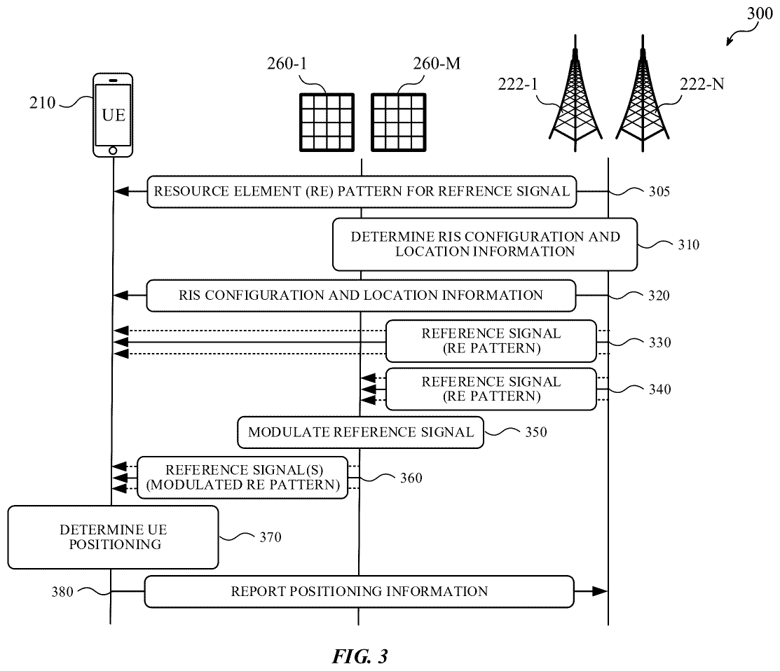

FIG. 3 is a diagram of an example process for enhanced positioning using RIS according to one or more implementations described herein. Process 300 can be implemented by UE 210, one or more base stations 222-1, . . . 222-N, and one or more RISs 250-1, . . . 250-M. In some implementations, some or all of process 300 can be performed by one or more other systems or devices, including one or more of the devices of FIG. 2, including functions of CN 230. Additionally, process 300 can include one or more fewer, additional, differently ordered and/or arranged operations than those shown in FIG. 3. In some implementations, some or all of the operations of process 300 can be performed independently, successively, simultaneously, etc., of one or more of the other operations of process 300. Operations described below as being performed by a single base station can be performed by multiple base station 222. Similarly, operations described below as being performed by a single RIS 260 can be performed by multiple RISs 260. As such, the techniques described herein are not limited to a number, sequence, arrangement, timing, etc., of the operations or processes depicted in FIG. 3.

As shown, process 300 can include base station 222 can communicate a RE pattern configured for reference signals to UE (block 305). The RE pattern can include an indication of time and frequency resources that base station 222 can use for communicating a reference signal to UE 210. An example of such a reference signal can include a PRS. Additionally, or alternatively, the RE pattern can include a comb-like RE structure, such that REs used for the reference signal are not contiguous in either a time domain or frequency domain.

Process 300 can include determining a RIS configuration and location information for one or more RIS 260 (block 310). The location information can include a physical (e.g., geographical) location of RIS 260. The RIS configuration information can include an indication of a modulation scheme to be applied to signals received by RIS 260. As described herein, the modulation scheme can involve a shift in REs (e.g., a change in frequency and/or time) for retransmitting signals that are received by RIS 260.

The RIS configuration information can be particular to a device (e.g., device-specific) regarding communications from base station 222; to base station 222; from UE 210; to UE 210; or between base station 222 and UE 210. In some implementations, RIS 260 can be configured to apply a different modulation scheme to different types of base stations 222, different types of UEs 210, etc., as long as the different types of signal are distinct in time. In some implementations, the RIS configuration information can also, or alternatively, be specific to a time or type of signal received or to be transmitted by RIS 260. For example, RIS 260 can be configured to apply different modulation schemes to different types of signals, such that for example, a DL reference signal can be modulated differently than a UL signal as long as the different types of signal are distinct in time.

Process 300 can include base station 222 communicating the RIS configuration and location information to UE 210 (block 320). As such, UE 210 can become aware of a shift in time and/or frequency resources that RIS 260 can apply to references signals from base station 222. In some implementations, operations of blocks 305, 310, and 320 can occur in a different order, simultaneously, or included in the same operation. For example, base station 222 can provide UE 210 with information about the RE pattern used by base 222 for reference signals while also providing UE with RIS configuration and location information to UE 210. In another example, the location information of RIS 260 can be provided before or after the RE pattern for reference signals and RIS configuration information.

Process 300 can include base station 222 communicating a reference signal to UE 210 (block 330) and communicating a reference signal to RIS 260 (block 340). Base station 222 can provide the reference signal using the RE pattern indicated to UE 210. In some implementations, multiple base station 222 can communicate a reference signal to UE 210, and each reference signal can use a different RE patter particular to the transmitting base station 222. Process 300 can include RIS 260 receiving the reference signal and modulating the reference signal based on the modulation scheme of RIS 260 (block 350). In scenarios where multiple RISs 260 receive the reference signal, each RIS 260 can apply a different modulation scheme. Applying the modulation scheme to the reference signal can include shifting or changing one or more of the REs of the RE pattern used by base station 222. In some implementations, REs of one OFDM symbol can be modified in the same way, and a different shift can be applied to each OFDM symbol. Examples of modulation schemes are described in detail with reference to other Figures.

Process 300 can include UE 210 receiving the reference signal from base station 222 (block 330) according to the RE pattern (see, block 305) and receiving the reference signal from RIS 260 according to the modulated RE pattern (block 360). The modulated RE pattern can include a RE pattern that has been changed by applying the modulation scheme to the RE pattern used by base station 222. Process 300 can include UE 210 determining a position or location of UE 210 (block 370). The positioning can be determined based on the different characteristics of the reference signals, using DL-TDOA, round-trip-time (RTT), or another type of positioning procedure. For example, UE 210 can evaluate for the different geographic locations of base station 222 and one or more RISs 260, along with an arrival time of reference signals from base station 222 and one or more RISs 260 and based on the differences in locations and arrival times, UE 210 can determine a current geographic location of UE 210. In another example, UE 210 can determine the current location of UE 210 by exploiting the reflective property of the RIS, providing a ranging anchor that is synchronous in time with the transmitting TRP and allows to determine the location based on a one-way transmission between transmitting TRP and receiving TRP, and transmitting TRP, RIS, and receiving TRP without the need for precise time synchronization.

In some implementations, process 380 can include UE 210 communicating or reporting the positioning information of UE 210 to base station 222. For example, for Multi-RTT base station 222 and UE 210 can perform receive (Rx) and transmit (Tx) time difference measurements, using PRS and SRS signaling, for the signal of each cell. An LMF or other core network function can initiate a procedure whereby multiple base stations and the UE perform the base station Rx-Tx and UE Rx-Tx measurements, respectively. Multi-RTT can have a higher positioning accuracy than TDoA-based methods and relaxes requirements on time synchronization.

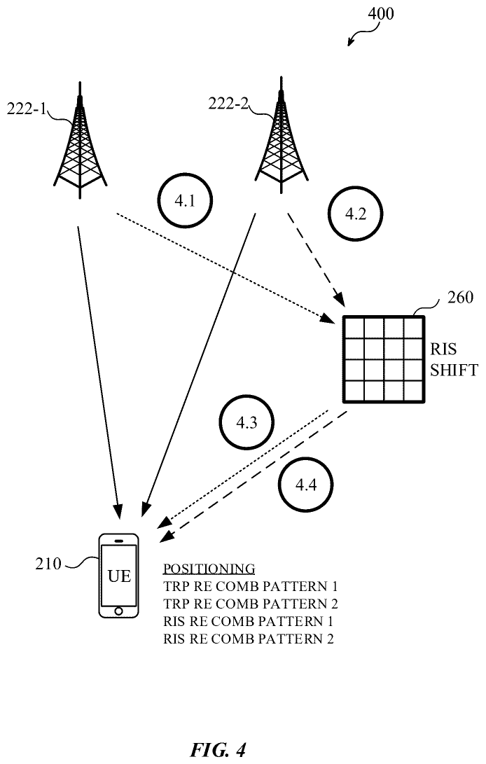

FIG. 4 is a diagram of an example 400 of UE positioning using one RIS according to one or more implementations described herein. As shown, example 400 can include UE 210, base stations 222-1 and 222-2, and RIS 260. Base stations 222-1 and 222-2 can communicate a reference signal (e.g., a PRS) to UE 210 and RIS 260 (at 4.1 and 4.2). In some implementations, RIS 260 does not recognize the reference signal. Instead, RIS 260 can be instructed about when to use which modulation. Base stations 222-1 and 222-2 can each use a different RE pattern for doing so, and each RE pattern can include a comb-like RE structure comprising noncontiguous REs in a time and/or frequency domain. RIS 260 can apply a modulation scheme to the RE patterns used by base station 222-1 and 222-2. In other scenarios, RIS 260 can apply a modulation scheme to an RE pattern used by UE 210.

The modulation scheme can be the same for both reference signals or different for each reference signal (e.g., provided that the reference signals are communicated at different times). The modulated scheme can include an RIS shift or change in REs in a time or frequency domain such that the reference signal is sent to UE 210 using a different (e.g., a modulated) RE pattern. An RIS shift can refer to a change in the RE pattern before and after modulation. UE 210 can receive the reference signals from base stations 222-1 and 222-2, and the modulated reference signals from RIS 260 (at 4.3 and 4.4). As described above with reference to FIG. 3, UE 210 can already be aware of a location of RIS 260 and can therefore determine positioning of UE 210 based on a combination of a Tx and RX time for each reference signal along with a physical location of base stations 222-1, 222-2, and RIS 260.

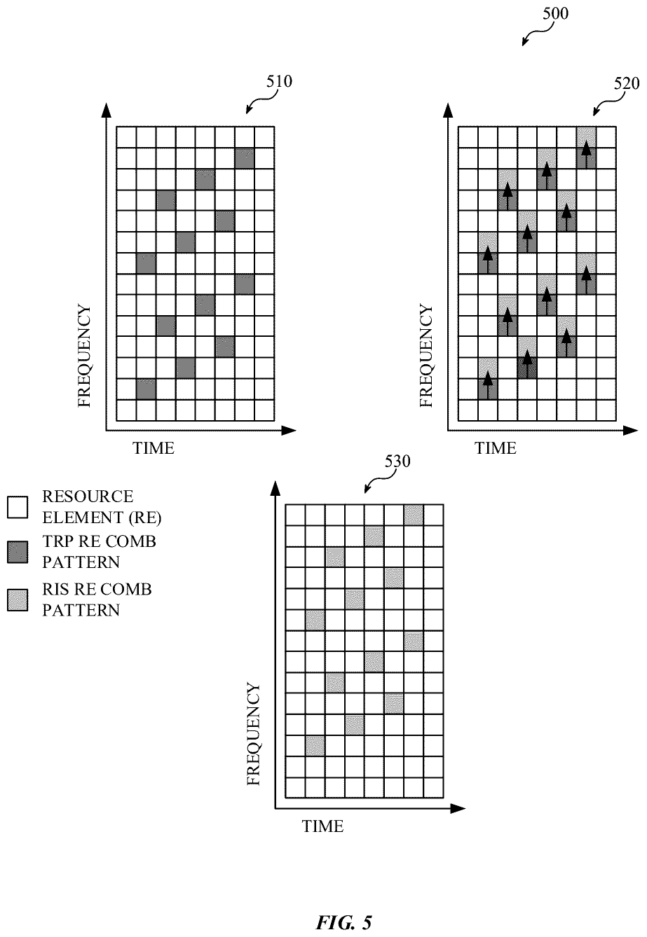

FIG. 5 is a diagram of an example 500 of RE comb structures 510, 520, and 530 according to one or more implementations described herein. RE comb structure 510 can refer to a RE pattern used by base station 222 or UE 210 to transmit a reference signal. The RE pattern can be a comb structure or comb-like structure as none of the REs are contiguous with respect to any other RE in the structure. RE comb structure 520 can refer to a modulation scheme applied to the RE pattern used by base station 222 for the reference signal. As shown, the modulation scheme of example 500 can include RIS shifting each RE of the comb structure up by one RE in a frequency domain. No change is applied to the time domain. RE comb structure 530 can represent the modulated RE pattern used by RIS 260 to communicate the reference signal to UE 210.

When base station 222 is the Tx TRP and UE 210 is the Rx TRP, UE 210 can receive RE comb structure 510 from base station 222 and RE comb structure 530 from RIS 260. Similarly, when UE 210 is the Tx TRP and base station 222 is the Rx TRP, base station 222 can receive RE comb structure 510 from UE 210 and RE comb structure 530 from RIS 260. Referring to FIG. 4, as example 400 include two base stations as Tx TRP, UE 210 would receive reference signals with different RE patterns from each of base stations 222-1 and 222-2 and, in turn, another set of reference signals with different modulated patterns as well.

As such, a PRS and SRS can be transmitted by a TRP (e.g., base station 222 or UE 210) using a RE comb-like pattern or structure. In some implementations, the RE pattern can have up to 12 transmitters to operate simultaneously, each transmitter having its own time-frequency RE pattern. The unique time-frequency patterns for the multiple transmitting TRPs can be generated by shifting an initial pattern in frequency direction. This way, an interleaved RE structure can generated where all transmitting TRPs use complementary time-frequency resource elements. RIS 260 can perform a frequency shift by one (or more) subcarrier spacings represented as: f_{shift}=±kΔf, k ∈_N+, where f can be a frequency, k can be a constant, and N+ can be a positive integer number larger than or equal to 1. Thereby, a different variant of RE comb-like pattern or structure can be generated that is orthogonal to the initial (or received) RE comb-like pattern or structure. This can allow up to 11 RISs 260 with paths that can be identified uniquely at a receiving TRP (e.g., a UE 210) plus the unaffected direct path from the Tx TRP (e.g., base station 222). Alternatively, any mixture of number of Tx TRPs and number of RISs 260 can be used while N_{RIS}×N_{TX} is greater than or equal to N_{comb,max}, where N_{RIS} is a number of RISs 260, N_{TX} is a number of Tx TRPs, and N_{comb,max} is a maximum number of RE comb-like patterns or structures.

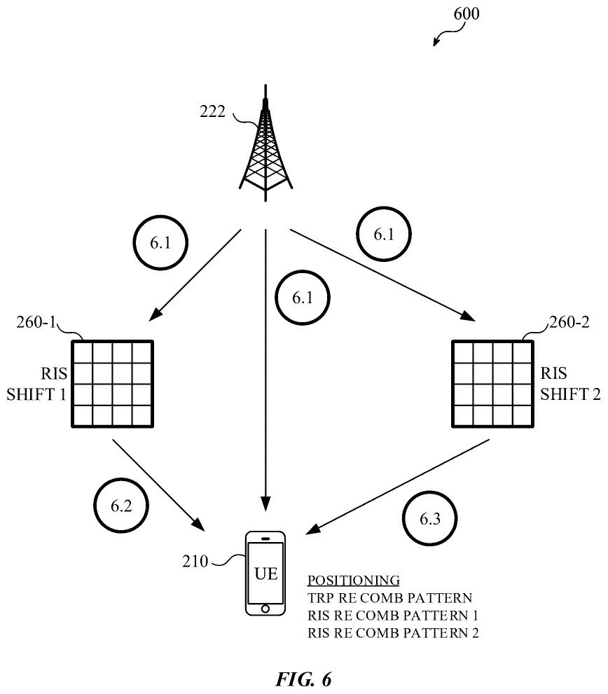

FIG. 6 is a diagram of an example 600 of UE positioning using multiple RIS according to one or more implementations described herein. As shown, example 600 can include UE 210, base stations 222, and RISs 260-1 and 260-2. Base station 222 can communicate a reference signal (e.g., a PRS) to UE 210, RISs 260-1, and RIS 260-2 (at 6.1). Base station 222 can use an RE pattern for doing so, which can include a comb-like RE structure comprising noncontiguous REs in a time and/or frequency domain. RISs 260-1 and 260-2 can each apply a different modulation scheme to the RE patterns used by base station 222.

The modulated scheme can include an RIS shift or change in REs in a time or frequency domain such that the reference signal is sent to UE 210 using different (e.g., a modulated) RE patterns. In some implementations, the change can only occur on a per OFDM symbol basis (e.g., the change can be the same for all frequency components of some specific time instance). An RIS shift can refer to a change in the RE pattern before and after modulation. UE 210 can receive the reference signals from base stations 222, RIS 260-1, and RIS 260-2 (at 6.2 and 6.3). As described above with reference to FIG. 3, UE 210 can already be aware of a location of RISs 260-1 and 260-2 and can therefore determine positioning of UE 210 based on a combination of a Tx and RX time for each reference signal along with a physical location of base station 222, RISs 260-1, and 260-2.

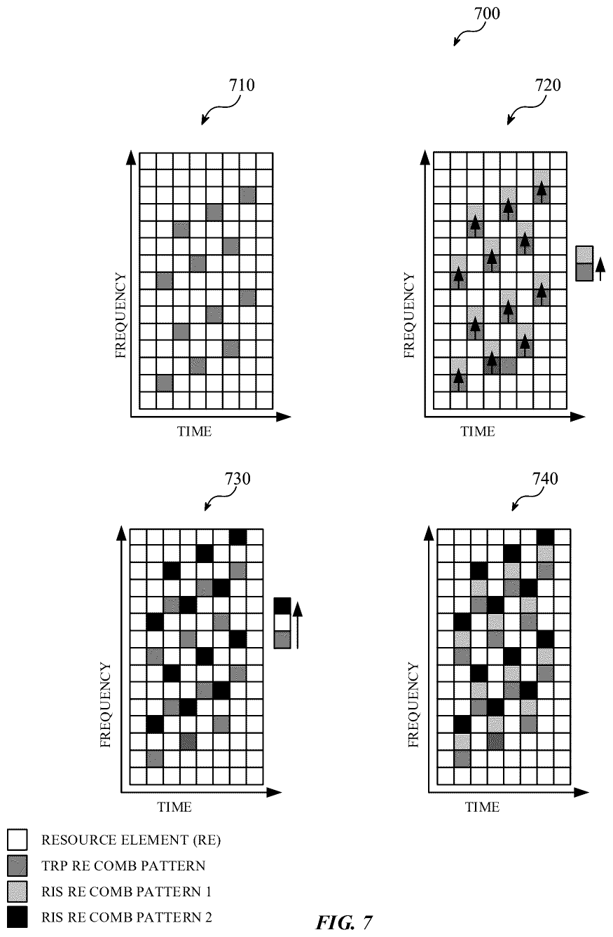

FIG. 7 is diagram of an example 700 of RE comb structures according to one or more implementations described herein. RE comb structure 710 can refer to a RE pattern used by base station 222 to transmit a reference signal (e.g., a PRS) in the DL direction or by UE 210 to transmit a reference signal (e.g., an SRS) in the UL direction. The RE pattern can be a comb structure or comb-like structure as none of the REs are contiguous with respect to any other RE in the structure. RE comb structure 720 can refer to a modulation scheme applied by a first RIS (e.g., RIS 260-1) to the original RE pattern used for the reference signal. As shown, the modulation scheme can include RIS 260-1 shifting each RE of the comb structure up by one RE in a frequency domain. No change is applied to the time domain.

RE comb structure 730 can refer to a modulation scheme applied by a second RIS (e.g., RIS 260-2) to the original RE pattern used for the reference signal. As shown, the modulation scheme can include RIS 260-2 shifting each RE of the comb structure up by two REs in a frequency domain. No change is applied to the time domain. RE comb structure 740 can represent a combination of RE patterns received by a Rx TRP (e.g., UE 210 for DL reference signals, base station 222 for UL reference signals, etc.). The original RE pattern 710, the first modulated RE pattern 720, and the second modulated RE partner 730 can be synchronized or otherwise cohesive with respect to one another such that none of the RE patterns overlap or interfere with one other.

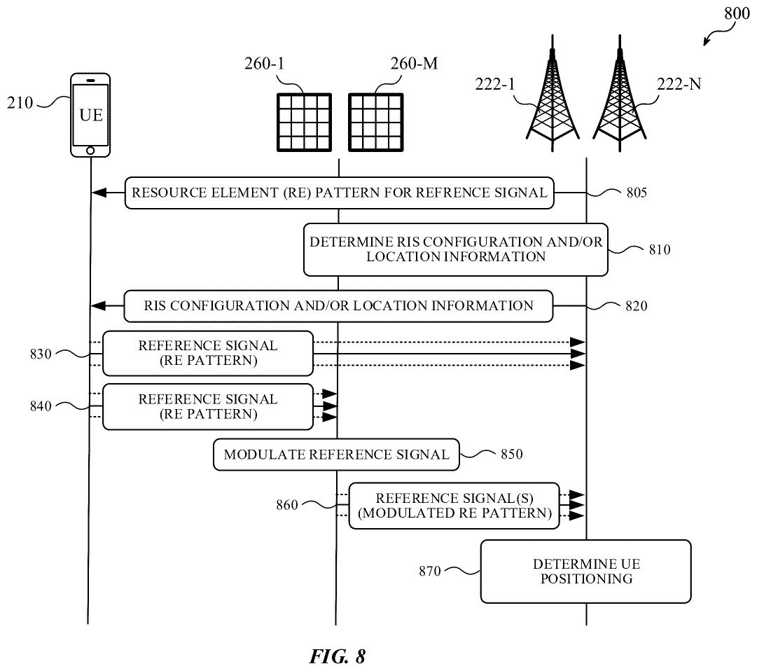

FIG. 8 is a diagram of an example process for enhanced positioning using RIS according to one or more implementations described herein. Process 800 can be implemented by UE 210, one or more base stations 222-1, . . . 222-N, and one or more RISs 250-1, . . . 250-M. In some implementations, some or all of process 800 can be performed by one or more other systems or devices, including one or more of the devices of FIG. 2, including functions of CN 230. Additionally, process 800 can include one or more fewer, additional, differently ordered and/or arranged operations than those shown in FIG. 8. In some implementations, some or all of the operations of process 800 can be performed independently, successively, simultaneously, etc., of one or more of the other operations of process 800. Operations described below as being performed by a single base station can be performed by multiple base station 222. Similarly, operations described below as being performed by a single RIS 260 can be performed by multiple RISs 260. As such, the techniques described herein are not limited to a number, sequence, arrangement, timing, etc., of the operations or processes depicted in FIG. 8.

As shown, process 800 can include base station 222 can communicate a RE pattern configured for reference signals to UE (block 805). The RE pattern can include an indication of time and frequency resources that UE 210 can use for communicating a reference signal to base station 222. An example of such a reference signal can include an SRS. Additionally, or alternatively, the RE pattern can include a comb-like RE structure, such that REs used for the reference signal are not contiguous in either a time domain or frequency domain. In some implementations, base station 222 can also provide UE with RE pattern information for a PRS that base station 222 can communicate to UE 210 (see, e.g., FIG. 3).

Process 800 can include determining a RIS configuration and location information for one or more RIS 260 (block 810). The location information can include a physical (e.g., geographical) location of RIS 260. The RIS configuration information can include an indication of a modulation scheme to be applied to signals received by RIS 260. As such, base station 222 can become aware of a shift in time and/or frequency resources that RIS 260 can apply to references signals from UE 210. As described herein, the modulation scheme can involve a shift in REs (e.g., a change in frequency and/or time) for reflecting, forwarding, or retransmitting signals that are received by RIS 260.

The RIS configuration information can be for device-specific communications from base station 222; to base station 222; from UE 210; to UE 210; or between base station 222 and UE 210. In some implementations, RIS 260 can be configured to apply a different modulation scheme to different types of base stations 222, different types of UEs 210, etc. In some implementations, the RIS configuration information can also, or alternatively, be specific to a time or type of signal received or to be transmitted by RIS 260. For example, RIS 260 can be configured to apply different modulation schemes to different types of signals, such that for example, a DL reference signal can be modulated differently than a UL signal, as long as the different types of signal are distinct in time.

Process 800 can include base station 222 communicating the RIS configuration and location information to UE 210 (block 820). As such, UE 210 can become aware of a shift in time and/or frequency resources that RIS 260 can apply to references signals from base station 222. Additionally, or alternatively, UE 210 can become aware of a location of RIS 260, such that UE 210 can communicate an UL reference signal (e.g., an SRS) to base station 222 via RIS 260. In some implementations, operations of blocks 805, 810, and 820 can occur in a different order, simultaneously, or included in the same operation. For example, base station 222 can provide UE 210 with information about the RE pattern used by base station 222 for reference signals while also providing UE with RIS configuration and location information to UE 210. In another example, the location information of RIS 260 can be provided before or after the RE pattern for reference signals and RIS configuration information.

Process 800 can include UE 210 communicating a reference signal to base station 222 (block 830) and communicating a reference signal to RIS 260 (block 840). UE 210 can provide the reference signal using the RE pattern indicated by base station 222 (see, block 805). In some implementations, UE 210 can communicate reference signals to multiple base stations 222. In some implementations, each reference signal can use a different RE pattern particular to the receiving base station 222. Process 800 can include RIS 260 receiving the reference signal and modulating the reference signal based on the modulation scheme of RIS 260 (block 850). In scenarios where multiple RISs 260 receive the reference signal, each RIS 260 can apply a different modulation scheme. Applying the modulation scheme to the reference signal can include shifting or changing one or more of the REs of the RE pattern used by base station 222. In some implementations, REs of one OFDM symbol can be modified in the same way, and a different shift can be applied to each OFDM symbol. Examples of modulation schemes are described in detail with reference to other Figures.

Process 800 can include base station 222 receiving the a reference signal from UE 210 (block 830) according to the RE pattern (see, block 805) and receiving the reference signal from RIS 260 according to the modulated RE pattern (block 860). The modulated RE pattern can include a RE pattern that has been changed by applying the modulation scheme to the RE pattern used by base station 222. Process 800 can include base station 222 determining a position or location of UE 210 (block 870). In some implementations, UE 210 can send a reference signal to multiple base station 222, and RIS 260 can modulate each reference signal before relaying the reference signal to the appropriate base station 222, such that each base station 222 receives an original (e.g., non-modulated) reference signal from UE 210 and a corresponding modulated reference signal form RIS 260. In such a scenario, base stations 222 can communicate with one another based on the locations of base station 222, each RIS 260, and a difference in arrival times of the modulated and non-modulated reference signals. The positioning can be determined based on the different characteristics of the reference signals, using UL-TDoA, multi-RTT, RTT, or another type of positioning procedure. While not shown, process 800 can include one or more other operations, such that PRS and SRS signaling can be used for enhanced positioning by UE 210 and base station 222 sharing Rx and Tx time difference measurements for PRS and SRS signaling and sending measurement results and other information toe an LMF or other core network function for positioning purposes. In another example, UE 210 can determine the current location of UE 210 by exploiting the reflective property of the RIS, providing a ranging anchor that is synchronous in time with the transmitting TRP and allows UE 210 to determine the location based on a one-way transmission between transmitting TRP and receiving TRP, and transmitting TRP, RIS, and receiving TRP without the need for precise time synchronization.

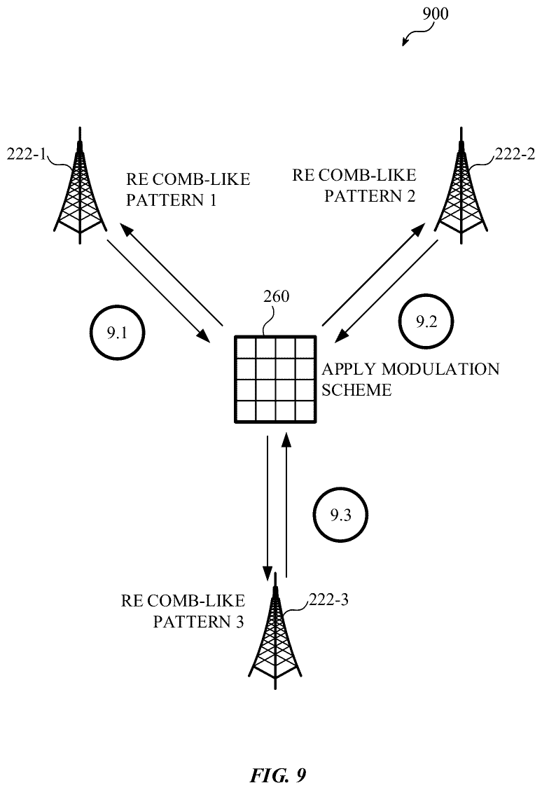

FIG. 9 is a diagram of an example 900 of determining a position of an RIS according to one or more implementations described herein. As shown, example 900 can include base stations 222-1, 222-2, and 222-3, and RIS 260. In some implementations, process 900 can include another type of TRP other than base stations 222-1, 222-2, and 222-3, such as one or more UEs 210 or other devices of FIG. 2. Base stations 222-1, 222-2, and 222-3 can each communicate a reference signal (e.g., a PRS) to RIS 260 using a different RE pattern or structure (e.g., RE comb-like patterns 1, 2, and 3 (at 9.1, 9.2., and 9.3). RIS 260 can receive the reference signals, apply a modulation scheme to each reference signal, and reflect or otherwise transmit the modulated reference signals back to base stations 222-1, 222-2, and 222-3 (at 9.1, 9.2., and 9.3). Base stations 222-1, 222-2, and 222-3 can apply a RTT analysis to the reference signals to determine a distance between each base station and RIS 260. In some implementations, base stations 222-1, 222-2, and 222-3 can share the results of the RTT analyses to determine a physical location or position of RIS 260.

As such, TRPs can illuminate RIS 260 sequentially with a PRS pattern of each TRP. RIS 260 can perform a frequency shift, represented by kAf, and select RIS phase-shifts to perform retro-reflection to the illuminating TRP. The TRP can receive the frequency shifted signal and estimates a corresponding RTT. This process can be repeated for all participating TRPs. Due to RIS modulation and retro-reflection, each path can be identified uniquely and distinguished from reflections of the environment. Self-interference can be reduced due to the frequency shift. When supported by RIS 260, the TRPs can illuminate the RIS simultaneously by using their individual PRS patterns.

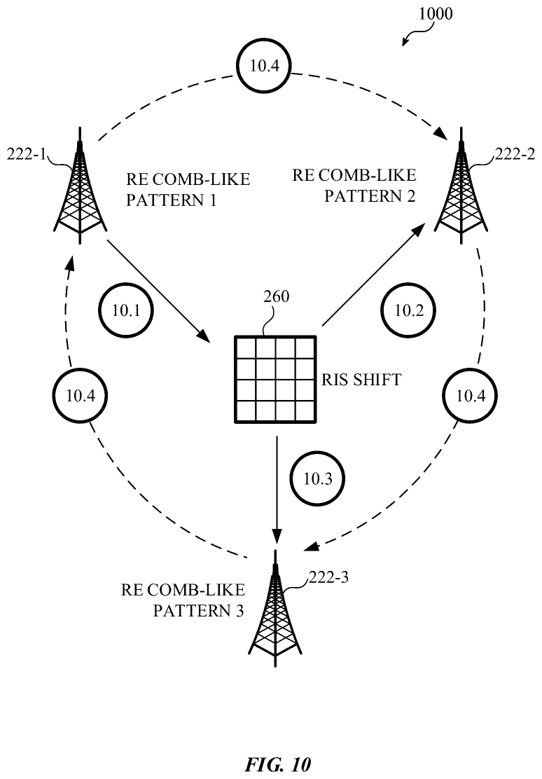

FIG. 10 is a diagram of an example 1000 of determining a position of an RIS according to one or more implementations described herein. As shown, example 1000 can include base stations 222-1, 222-2, and 222-3, and RIS 260. In some implementations, can include another type of TRP other than base stations 222-1, 222-2, and 222-3, such as one or more UEs 210 or other devices of FIG. 2.

Base station 222-1, 222-2, and 222-3 can illuminate RIS 260 sequentially with their PRS patterns. For example, base station 222-1 can transmit a reference signal to RIS 260 (at 10.1). RIS 260 can perform a frequency shift (e.g., modulation) and select an RIS phase-shift to perform reflection to base stations 222-2 and 222-3 (at 10.2 and 10.3). Doing so can involve RIS 260 generating two reflection angles simultaneously. Alternatively, sequential reflection to stations 222-2 and 222-3 can be performed. Base stations 222-2 and 222-3 can receive the frequency shifted signal and estimate a time of arrival. This process can be repeated by base stations 222-1, 222-2, and 222-3, and RIS 260 such that base station 222 has the role of Tx TRP once (at 10.4). Due to RIS modulation, each path can be identified uniquely. With awareness of the locations of base stations 222-1, 222-2, and 222-3 and the calculated RTT based on bi-directional transmission, the location or positioning of RIS 260 can be calculated by base stations 222-1, 222-2, and 222-3. The calculation can be supported by direction of arrival (DoA) measurements at the Rx TRPs and measurements of line-of-sight (LOS) between base stations 222 based on the same transmissions.

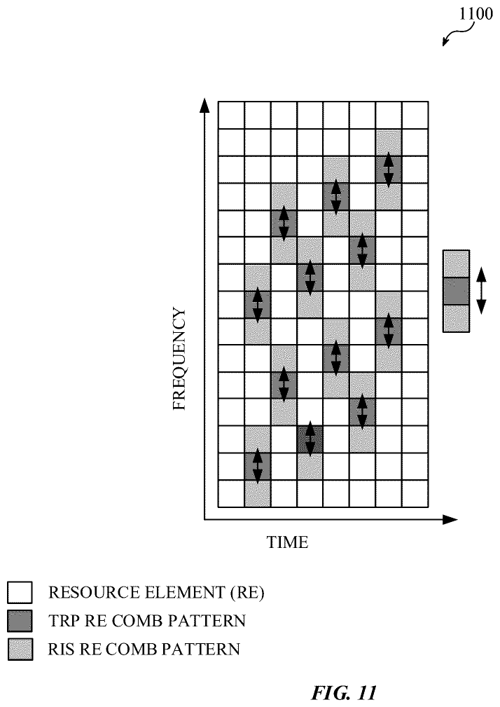

FIG. 11 is a diagram of an example 1100 of a RE comb structure and modulation scheme using double-sideband modulation according to one or more implementations described herein. RIS 260 can apply double-sideband modulation in a frequency domain to an original RE pattern used by a Tx TRP for a reference signal. As a non-limiting example, the modulated RE pattern resulting from the modulation scheme can include an RE immediately above, and another RE immediately below, each RE of the original RE pattern. This can involve no change in a time domain. In some implementations, there can be a change in the time domain. Additionally, the proximity (in the time or frequency domain) of the modulated REs relative to the REs of the original RE pattern can vary.

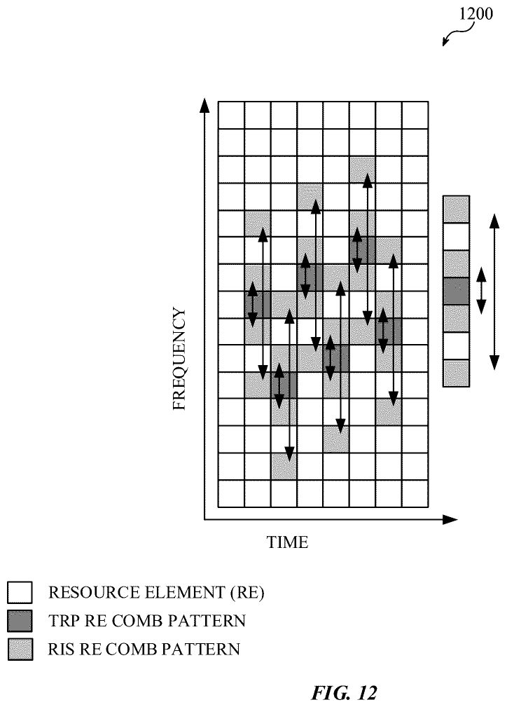

FIG. 12 is a diagram of an example 1200 of a RE comb structure using double-sideband, multi-tone modulation according to one or more implementations described herein. RIS 260 can apply double-sideband, multi-tone modulation in a frequency domain to an original RE pattern used by a Tx TRP for a reference signal. As a non-limiting example, the modulated RE pattern resulting from the modulation scheme can include an RE immediately above, and another RE immediately below, each RE of the original RE pattern. It can also include an RE two REs removed (above and below) each RE of the original RE pattern. This can involve no change in a time domain. In some implementations, there can be a change in the time domain. Additionally, the proximity (in the time or frequency domain) of the modulated REs relative to the REs of the original RE pattern can vary. The number of multi-tone components may also, or alternatively, vary.

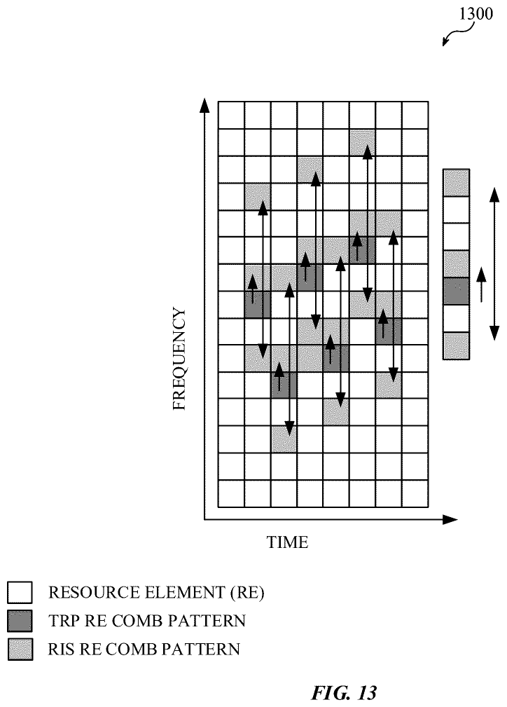

FIG. 13 is a diagram of an example 1300 of an arbitrary RE comb structure according to one or more implementations described herein. RIS 260 can apply arbitrary modulation in a frequency domain to an original RE pattern used by a Tx TRP for a reference signal. As a non-limiting example, the modulated RE pattern resulting from the modulation scheme can include an RE immediately above an each RE of the original RE pattern; another RE (three REs removed) above each RE of the original RE pattern; and yet another RE (one RE removed) below each RE of the original RE pattern. As shown, an arbitrary modulation scheme can involve no change in a time domain. In some implementations, an arbitrary modulation scheme can include or be combined with a change in the time domain. Additionally, the proximity (in the time or frequency domain) of the modulated REs relative to the REs of the original RE pattern can vary. An arbitrary modulation scheme can strengthen security as modulated reference signals would be more difficult to intercept or anticipate. The number of multi-tone components may also, or alternatively, vary.

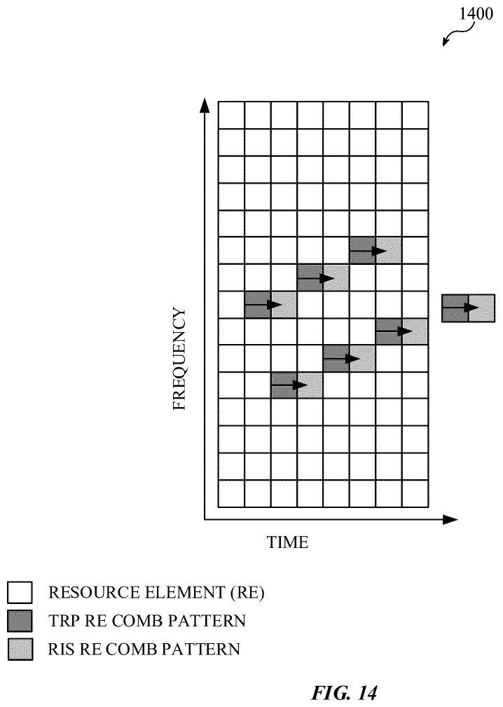

FIG. 14 is a diagram of an example 1400 of a RE comb structure using a time delay according to one or more implementations described herein. RIS 260 can apply a modulation scheme that involves a time domain shift of REs of an original RE pattern used by a Tx TRP for a reference signal. As a non-limiting example, the modulated RE pattern resulting from a modulation scheme involving a time domain can include a time domain delay. In example 1400, each RE of the original RE pattern is delayed by one symbol or RE in the time domain. As shown, a modulation scheme involving a time delay can involve no change in a frequency domain. In some implementations, a modulation scheme involving a time delay can include or be combined with a change in the frequency domain. Additionally, the proximity (in the time or frequency domain) of the modulated REs relative to the REs of the original RE pattern can vary.

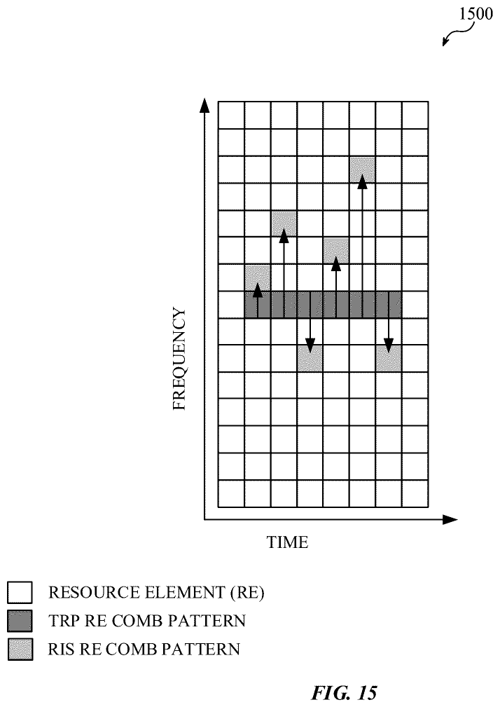

FIG. 15 is a diagram of an example 1500 of REs using a symbol-wise frequency shift according to one or more implementations described herein. An original RE pattern used by a Tx TRP for a reference signal can include REs that are the same in a frequency domain and contiguous in a time domain. RIS 260 can apply a modulation scheme that maintains the contiguousness in the time domain but varies greatly in the frequency domain.

As shown for example, a first or earliest RE of the time domain can be shifted upward one RE in the frequency domain; a second RE of the time domain can be shifted upward three REs in the frequency domain; a third RE of the time domain can be shifted downward by two REs, and so on. Individual REs may not be shifted, but all REs of a symbol may be shifted. As such, a modulation scheme can maintain consistency with the original RE pattern in one domain but introduce significant or arbitrary variety in another domain. Doing so can promote security as the modulated RE pattern can be more difficult to anticipate.

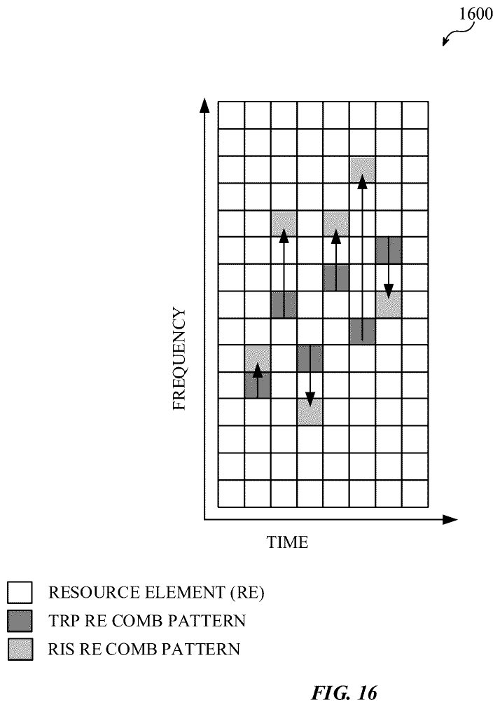

FIG. 16 is a diagram of an example 1600 of REs for secure positing with RIS according to one or more implementations described herein. An original RE pattern used by a Tx TRP for a reference signal can include a comb-like RE structure. The RE pattern can be comp-like as the REs are staggered in the frequency domain while being contiguous in a time domain. RIS 260 can apply a modulation scheme that maintains the contiguousness in the time domain but varies greatly in the frequency domain.

As shown for example, a first or earliest RE of the time domain can be shifted upward one RE in the frequency domain; a second RE of the time domain can be shifted upward three REs in the frequency domain; a third RE of the time domain can be shifted downward by two REs, a fourth RE of the time domain can be shifted upward two REs in the frequency domain (to occupy the same frequency domain as the second RE of the time domain); and so on. As such, a modulation scheme maintain consistency with the original RE pattern in one domain but introduce significant or arbitrary variety in another domain, even when the original RE pattern is already in a staggered or comb-like structure.

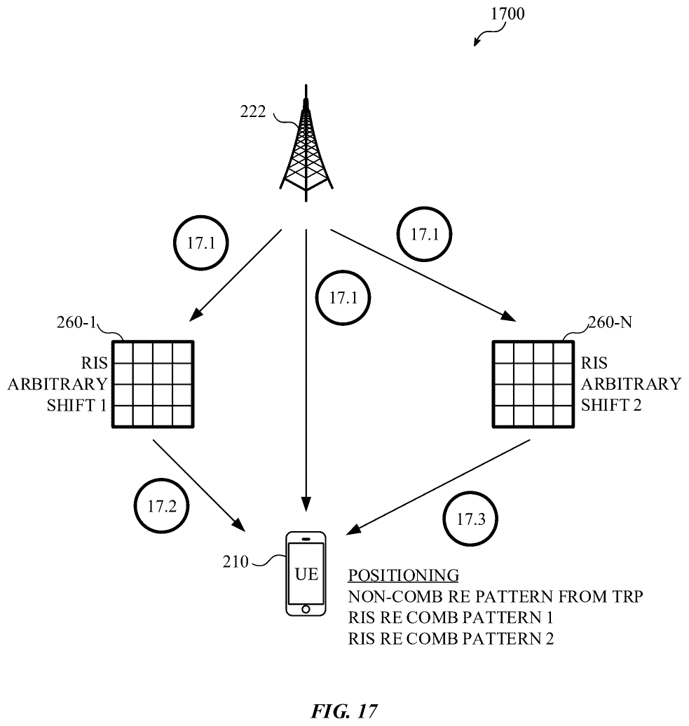

FIG. 17 is a diagram of an example 1700 of UE using RIS separation in a frequency-shift-based code-domain according to one or more implementations described herein. As shown, example 1700 can include UE 210, base stations 222, and RISs 260-1 and 260-2. Base station 222 can communicate a reference signal (e.g., a PRS) to UE 210, RISs 260-1, and RIS 260-2 (at 17.1). Base station 222 can use an RE pattern for doing so, which can include a RE structure comprising contiguous REs in a time domain and the same REs in a frequency domain. RISs 260-1 and 260-2 can each apply a different modulation scheme to the RE pattern used by base station 222.

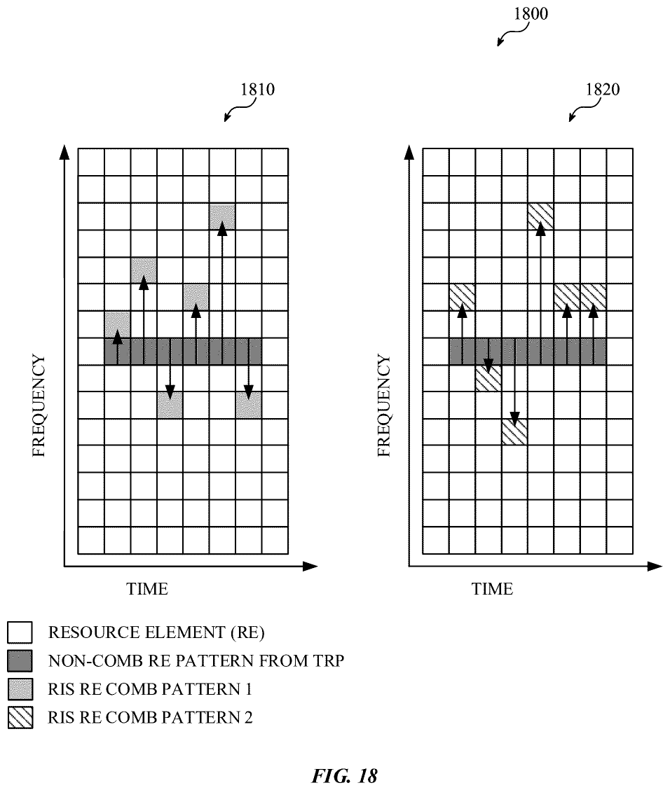

The modulated scheme can include an RIS arbitrary shift or arbitrary change in REs in a frequency domain such that the reference signal is sent to UE 210 using different (e.g., a modulated) RE patterns. UE 210 can receive the reference signals from base stations 222, RIS 260-1, and RIS 260-2 (at 17.2 and 17.3). The reference signal from base station 222 can be a non-comb RE pattern from a TRP (e.g., from base station 222); a RIS RE comb pattern 1 resulting from RIS arbitrary shift 1; and a RIS RE comb pattern 2 resulting from RIS arbitrary shift 2. UE 210 can determine positioning (e.g., the geographic location of UE) based on the Examples of the RE pattern used by base station 222, and the modulation schemes applied by RISs 260-1 and 260-2 are described below with reference to FIG. 18.

FIG. 18 is a diagram of examples 1800 of RE patterns using RIS separation in a frequency-shift-based code-domain according to one or more implementations described herein. A transmitting TRP (e.g., base station 222) can use an arbitrary Tx signal (e.g., a come-like RE structure or pattern is not required). Individual frequency shifts per symbol can enable secure RIS positioning, in addition to generating an additional domain for signal separation. The individual shift in frequency direction can allow separation of multiple RIS signals in a frequency-code-domain. Each RIS can have a unique shift pattern over time. The RE patterns do not need to be exclusive or orthogonal. Additionally, it is tolerable that REs be used by multiple RIS signals (e.g., strict orthogonality in time/frequency domain is not required). A receiver can use separation in the code-domain by coherently combining the symbols based on each RIS's modulation scheme (or shifting pattern). The shifting pattern can be known to RIS 260 and receiving TRP (e.g., UE 210) and can be shared/assigned during initial access/pre-configuration. A shift by integer multiples can be used but is not required. Separation of REs can be in a code domain, and evaluation of signals from RIS 260 can be performed by a receiving TRP (e.g., UE 210) by undoing a frequency shift of each RIS signal separately.

Referring to the examples and Figures described above, deployments can be RIS-centric (e.g., they can rely primarily on RIS 260, or they can be used to extend existing positioning architectures based on multiple TRPs). A reference signal (e.g., PRS) pattern used is not limited to those explicitly shown. In the case of a modulation process that does not remove an unshifted reflection, identification of RIS reflections is still possible, but there can be a need to have a separate transmission without the RIS 260 being active to determine the LOS or environment paths. Implementations can serve multiple receiving TRPs (e.g., UEs) simultaneously.

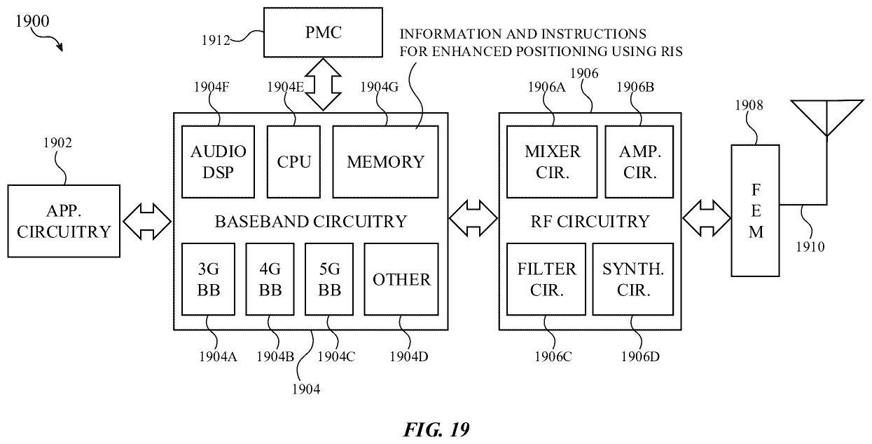

FIG. 19 is a diagram of an example of components of a device 1900 according to one or more implementations described herein. In some implementations, the device 1900 can include application circuitry 1902, baseband circuitry 1904, RF circuitry 1906, front-end module (FEM) circuitry 1908, one or more antennas 1910, and power management circuitry (PMC) 1912 coupled together at least as shown. The components of the illustrated device 1900 can be included in a UE or a RAN node. In some implementations, the device 1900 can include fewer elements (e.g., a RAN node may not utilize application circuitry 1902, and instead include a processor/controller to process IP data received from a CN or an Evolved Packet Core (EPC)). In some implementations, the device 1900 can include additional elements such as, for example, memory/storage, display, camera, sensor (including one or more temperature sensors, such as a single temperature sensor, a plurality of temperature sensors at different locations in device 1900, etc.), or input/output (I/O) interface. In other implementations, the components described below can be included in more than one device (e.g., said circuitries can be separately included in more than one device for Cloud-RAN (C-RAN) implementations).

The application circuitry 1902 can include one or more application processors. For example, the application circuitry 1902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1900. In some implementations, processors of application circuitry 1902 can process IP data packets received from an EPC.

The baseband circuitry 1904 can include circuitry such as, but not limited to, one or more single-core or multi-core processors. The baseband circuitry 1904 can include one or more baseband processors or control logic to process baseband signals received from a receive signal path of the RF circuitry 1906 and to generate baseband signals for a transmit signal path of the RF circuitry 1906. Baseband circuitry 1904 can interface with the application circuitry 1902 for generation and processing of the baseband signals and for controlling operations of the RF circuitry 1906. For example, in some implementations, the baseband circuitry 1904 can include a 3G baseband processor 1904A, a 4G baseband processor 1904B, a 5G baseband processor 1904C, or other baseband processor(s) 1904D for other existing generations, generations in development or to be developed in the future (e.g., 5G, 6G, etc.). The baseband circuitry 1904 (e.g., one or more baseband processors 1904A-D) can handle various radio control functions that enable communication with one or more radio networks via the RF circuitry 1906. In other implementations, some or all of the functionality of baseband processors 1904A-D can be included in modules stored in the memory 1904G and executed via a Central Processing Unit (CPU) 1904E. The radio control functions can include, but are not limited to, signal modulation/demodulation, encoding/decoding, radio frequency shifting, etc. In some implementations, modulation/demodulation circuitry of the baseband circuitry 1904 can include Fast-Fourier Transform (FFT), precoding, or constellation mapping/de-mapping functionality. In some implementations, encoding/decoding circuitry of the baseband circuitry 1904 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1904G can receive and/or store information and instructions for enhanced positioning using RIS. A reference signal can be communicated from one TRP to another TRP. Either TRP could be a base station or a UE. The reference signal can also be communicated to one or more RISs. As each RIS can apply a different modulation scheme to the reference signal, the receiving TRP can distinguish between reference signals, as well as determine which reference signal came from which RIS. The positioning can be determined based on the different characteristics of the reference signals, using TDoA, Multi-RTT, RTT, or another type of positioning procedure. These and many other features and examples are discussed herein.

In some implementations, the baseband circuitry 1904 can include one or more audio digital signal processor(s) (DSP) 1904F. The audio DSPs 1904F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1904 and the application circuitry 1902 can be implemented together such as, for example, on a system on a chip (SOC).

In some implementations, the baseband circuitry 1904 can provide for communication compatible with one or more radio technologies. For example, in some implementations, the baseband circuitry 1904 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1904 is configured to support radio communications of more than one wireless protocol can be referred to as multi-mode baseband circuitry.

RF circuitry 1906 can enable communication with wireless networks using modulated electromagnetic radiation through a non-solid medium. In various implementations, the RF circuitry 1906 can include switches, filters, amplifiers, etc. to facilitate the communication with the wireless network. RF circuitry 1906 can include a receive signal path which can include circuitry to down-convert RF signals received from the FEM circuitry 1908 and provide baseband signals to the baseband circuitry 1904. RF circuitry 1906 can also include a transmit signal path which can include circuitry to up-convert baseband signals provided by the baseband circuitry 1904 and provide RF output signals to the FEM circuitry 1908 for transmission.

In some implementations, the receive signal path of the RF circuitry 1906 can include mixer circuitry 1906A, amplifier circuitry 1906B and filter circuitry 1906C. In some implementations, the transmit signal path of the RF circuitry 1906 can include filter circuitry 1906C and mixer circuitry 1906A. RF circuitry 1906 can also include synthesizer circuitry 1906D for synthesizing a frequency for use by the mixer circuitry 1906A of the receive signal path and the transmit signal path. In some implementations, the mixer circuitry 1906A of the receive signal path can be configured to down-convert RF signals received from the FEM circuitry 1908 based on the synthesized frequency provided by synthesizer circuitry 1906D. The amplifier circuitry 1906B can be configured to amplify the down-converted signals and the filter circuitry 1906C can be a low-pass filter (LPF) or band-pass filter (BPF) configured to remove unwanted signals from the down-converted signals to generate output baseband signals. Output baseband signals can be provided to the baseband circuitry 1904 for further processing. In some implementations, the output baseband signals can be zero-frequency baseband signals, although this is not a requirement. In some implementations, mixer circuitry 1906A of the receive signal path can comprise passive mixers, although the scope of the implementations is not limited in this respect.

In some implementations, the mixer circuitry 1906A of the transmit signal path can be configured to up-convert input baseband signals based on the synthesized frequency provided by the synthesizer circuitry 1906D to generate RF output signals for the FEM circuitry 1908. The baseband signals can be provided by the baseband circuitry 1904 and can be filtered by filter circuitry 1906C. In some implementations, the mixer circuitry 1906A of the receive signal path and the mixer circuitry 1906A of the transmit signal path can include two or more mixers and can be arranged for quadrature down conversion and up conversion, respectively. In some implementations, the mixer circuitry 1906A of the receive signal path and the mixer circuitry 1906A of the transmit signal path can include two or more mixers and can be arranged for image rejection (e.g., Hartley image rejection). In some implementations, the mixer circuitry 1906A of the receive signal path and the mixer circuitry 1406A can be arranged for direct down conversion and direct up conversion, respectively. In some implementations, the mixer circuitry 1906A of the receive signal path and the mixer circuitry 1906A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1906 can include analog-to-digital converter (ADC) and digital-to-analog converter (DAC) circuitry and the baseband circuitry 1904 can include a digital baseband interface to communicate with the RF circuitry 1906.

In some dual-mode implementations, a separate radio IC circuitry can be provided for processing signals for each spectrum, although the scope of the implementations is not limited in this respect. In some implementations, the synthesizer circuitry 1906D can be a fractional-N synthesizer or a fractional N/N+1 synthesizer, although the scope of the implementations is not limited in this respect as other types of frequency synthesizers can be suitable. For example, synthesizer circuitry 1906D can be a delta-sigma synthesizer, a frequency multiplier, or a synthesizer comprising a phase-locked loop with a frequency divider.

The synthesizer circuitry 1906D can be configured to synthesize an output frequency for use by the mixer circuitry 1906A of the RF circuitry 1906 based on a frequency input and a divider control input. In some implementations, the synthesizer circuitry 1906D can be a fractional N/N+1 synthesizer.

In some implementations, frequency input can be provided by a voltage-controlled oscillator (VCO), although that is not a requirement. Divider control input can be provided by either the baseband circuitry 1904 or the applications circuitry 1902 depending on the desired output frequency. In some implementations, a divider control input (e.g., N) can be determined from a look-up table based on a channel indicated by the applications circuitry 1902.

Synthesizer circuitry 1906D of the RF circuitry 1906 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1906D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1906 can include an IQ/polar converter.

FEM circuitry 1908 can include a receive signal path which can include circuitry configured to operate on RF signals received from one or more antennas 1910, amplify the received signals and provide the amplified versions of the received signals to the RF circuitry 1906 for further processing. FEM circuitry 1908 can also include a transmit signal path which can include circuitry configured to amplify signals for transmission provided by the RF circuitry 1906 for transmission by one or more of the one or more antennas 1910. In various implementations, the amplification through the transmit or receive signal paths can be done solely in the RF circuitry 1906, solely in the FEM circuitry 1908, or in both the RF circuitry 1906 and the FEM circuitry 1908.

In some implementations, the FEM circuitry 1908 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1906). The transmit signal path of the FEM circuitry 1908 can include a power amplifier (PA) to amplify input RF signals (e.g., provided by RF circuitry 1906), and one or more filters to generate RF signals for subsequent transmission (e.g., by one or more of the one or more antennas 1910).

In some implementations, the PMC 1912 can manage power provided to the baseband circuitry 1904. In particular, the PMC 1912 can control power-source selection, voltage scaling, battery charging, or DC-to-DC conversion. The PMC 1912 can often be included when the device 1900 is capable of being powered by a battery, for example, when the device is included in a UE. The PMC 1912 can increase the power conversion efficiency while providing desirable implementation size and heat dissipation characteristics.

While FIG. 19 shows the PMC 1912 coupled only with the baseband circuitry 1904. However, in other implementations, the PMC 1912 can be additionally or alternatively coupled with, and perform similar power management operations for, other components such as, but not limited to, application circuitry 1902, RF circuitry 1906, or FEM circuitry 1908.

In some implementations, the PMC 1912 can control, or otherwise be part of, various power saving mechanisms of the device 1900. For example, if the device 1900 is in an RRC_Connected state, where it is still connected to the RAN node as it expects to receive traffic shortly, then it can enter a state known as Discontinuous Reception Mode (DRX) after a period of inactivity. During this state, the device 1900 can power down for brief intervals of time and thus save power.

If there is no data traffic activity for an extended period of time, then the device 1900 can transition off to an RRC_Idle state, where it disconnects from the network and does not perform operations such as channel quality feedback, handover, etc. The device 1900 goes into a very low power state and it performs paging where again it periodically wakes up to listen to the network and then powers down again. The device 1900 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1902 and processors of the baseband circuitry 1904 can be used to execute elements of one or more instances of a protocol stack. For example, processors of the baseband circuitry 1904, alone or in combination, can be used execute Layer 3, Layer 2, or Layer 1 functionality, while processors of the baseband circuitry 1904 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

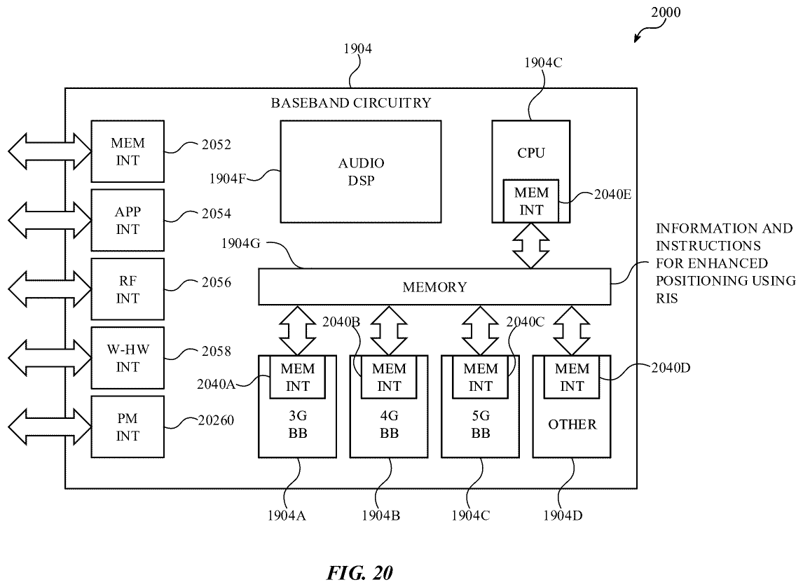

FIG. 20 is a diagram of example interfaces 2000 of baseband circuitry according to one or more implementations described herein. As discussed above, the baseband circuitry 1904 of FIG. 19 can comprise processors 1904A through 1904E and a memory 1904G utilized by said processors. Each of the processors 1904A through 1904E can include a memory interface, 2040A through 2040E, respectively, to send/receive data to/from the memory 1904G.

In some implementations, memory 1904G can receive, store, and/or provide information and instructions for enhanced positioning using RIS. A reference signal can be communicated from one TRP to another TRP. Either TRP could be a base station or a UE. The reference signal can also be communicated to one or more RISs. As each RIS can apply a different modulation scheme to the reference signal, the receiving TRP can distinguish between reference signals, as well as determine which reference signal came from which RIS. The positioning can be determined based on the different characteristics of the reference signals, using TDoA, Multi-RTT, RTT, or another type of positioning procedure. These and many other features and examples are discussed herein.

The baseband circuitry 1904 can further include one or more interfaces to communicatively couple to other circuitries/devices, such as a memory interface 1952 (e.g., an interface to send/receive data to/from memory external to the baseband circuitry 1904), an application circuitry interface 2054 (e.g., an interface to send/receive data to/from the application circuitry 1902 of FIG. 19), an RF circuitry interface 2056 (e.g., an interface to send/receive data to/from RF circuitry 1906 of FIG. 19), a wireless hardware connectivity interface 2058 (e.g., an interface to send/receive data to/from Near Field Communication (NFC) components, Bluetooth® components (e.g., Bluetooth® Low Energy), Wi-Fi® components, and other communication components), and a power management interface 2060 (e.g., an interface to send/receive power or control signals to/from the PMC 1912).

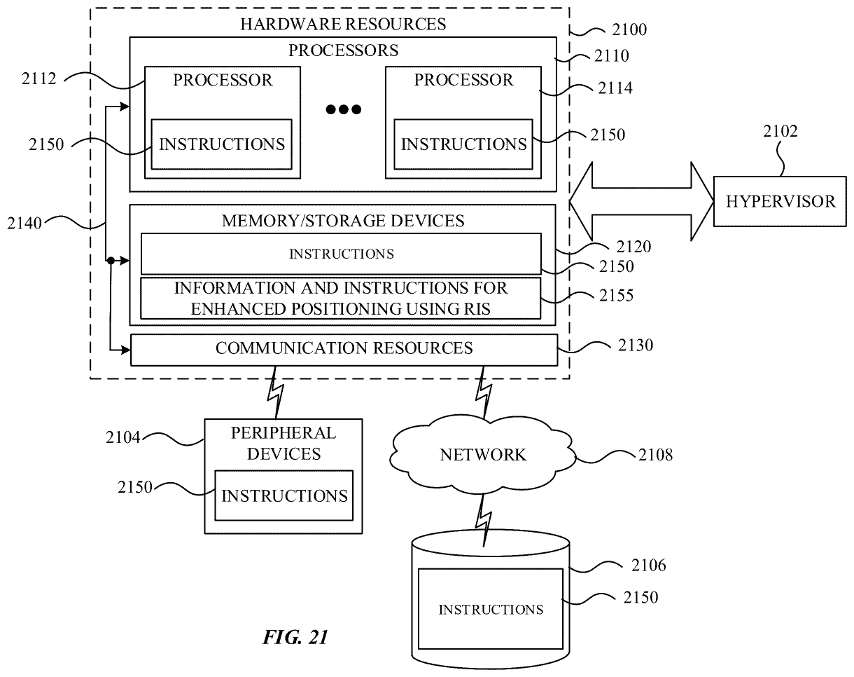

FIG. 21 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 21 shows a diagrammatic representation of hardware resources 2100 including one or more processors (or processor cores) 2110, one or more memory/storage devices 2120, and one or more communication resources 2130, each of which can be communicatively coupled via a bus 2140. For implementations where node virtualization (e.g., NFV) is utilized, a hypervisor can be executed to provide an execution environment for one or more network slices/sub-slices to utilize the hardware resources 2100.

The processors 2110 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 2112 and a processor 2114.

The memory/storage devices 2120 can include main memory, disk storage, or any suitable combination thereof. The memory/storage devices 2120 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 2120 receive and/or store information and instructions 2155 for enhanced positioning using RIS. A reference signal can be communicated from one TRP to another TRP. Either TRP could be a base station or a UE. The reference signal can also be communicated to one or more RISs. As each RIS can apply a different modulation scheme to the reference signal, the receiving TRP can distinguish between reference signals, as well as determine which reference signal came from which RIS. The positioning can be determined based on the different characteristics of the reference signals, using TDoA, Multi-RTT, RTT, or another type of positioning procedure. These and many other features and examples are discussed herein.

The communication resources 2130 can include interconnection or network interface components or other suitable devices to communicate with one or more peripheral devices 2104 or one or more databases 2106 via a network 2108. For example, the communication resources 2130 can include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 2150 can comprise software, a program, an application, an applet, an app, or other executable code for causing at least any of the processors 2110 to perform any one or more of the methodologies discussed herein. The instructions 2150 can reside, completely or partially, within at least one of the processors 2110 (e.g., within the processor's cache memory), the memory/storage devices 2120, or any suitable combination thereof. Furthermore, any portion of the instructions 2150 can be transferred to the hardware resources 2100 from any combination of the peripheral devices 2104 or the databases 2106. Accordingly, the memory of processors 2110, the memory/storage devices 2120, the peripheral devices 2104, and the databases 2106 are examples of computer-readable and machine-readable media.

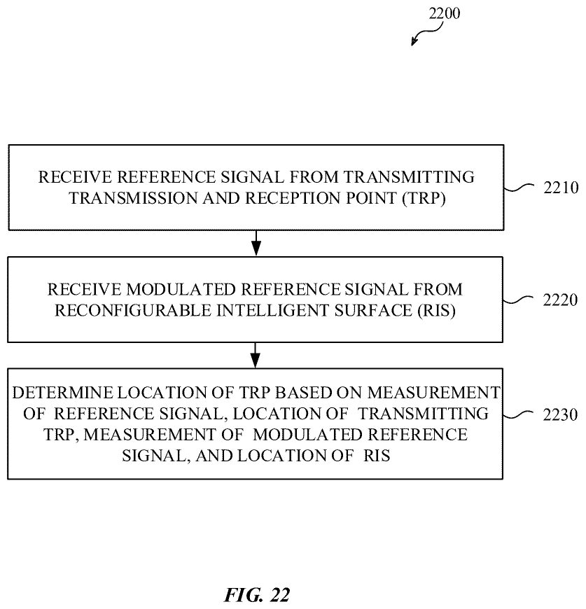

FIG. 22 is a diagram of an example process for enhanced positioning using RIS according to one or more implementations described herein. Process 2200 can be implemented by UE 210. In some implementations, some or all of process 2200 can be performed by one or more other systems or devices, including one or more of the devices of FIG. 2. Additionally, process 2200 can include one or more fewer, additional, differently ordered and/or arranged operations than those shown in FIG. 22. In some implementations, some or all of the operations of process 2200 can be performed independently, successively, simultaneously, etc., of one or more of the other operations of process 2200. As such, the techniques described herein are not limited to a number, sequence, arrangement, timing, etc., of the operations or processes depicted in FIG. 22.

Process 2200 can include receiving a reference signal from a transmitting transmission and reception point (TRP) (block 2210). Process 2200 can also include receiving a modulated reference signal from a reconfigurable intelligent surface (RIS) (block 2220). The modulated reference signal can result from a modulation scheme applied (e.g., by the RIS) to the reference signal of the transmitting TRP. Process 2200 can include determining a location of the TRP based on a measurement of the reference signal, a location of the transmitting TRP, a measurement of the modulated reference signal, and a location of the RIS (block 2230).

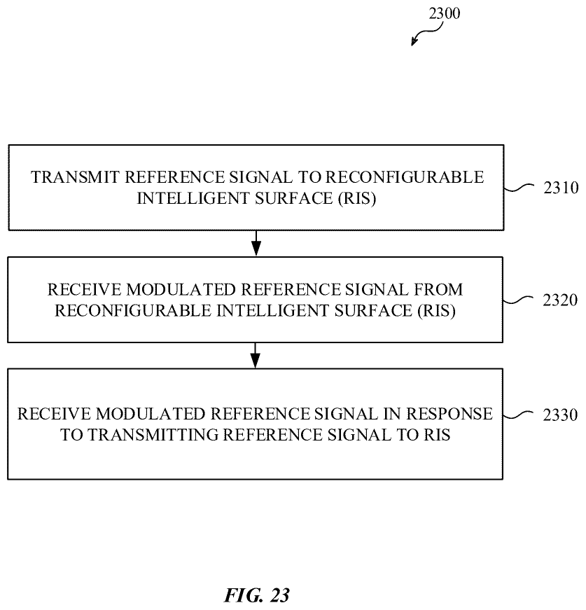

FIG. 23 is a diagram of an example process for enhanced positioning using RIS according to one or more implementations described herein. Process 2300 can be implemented by base station 222. In some implementations, some or all of process 2300 can be performed by one or more other systems or devices, including one or more of the devices of FIG. 2. Additionally, process 2300 can include one or more fewer, additional, differently ordered and/or arranged operations than those shown in FIG. 23. In some implementations, some or all of the operations of process 2300 can be performed independently, successively, simultaneously, etc., of one or more of the other operations of process 2300. As such, the techniques described herein are not limited to a number, sequence, arrangement, timing, etc., of the operations or processes depicted in FIG. 23.

Process 2300 can include transmitting reference signal to reconfigurable intelligent surface (RIS) (block 2310). Process 2300 can include receiving modulated reference signal in response to transmitting reference signal to RIS (block 2320). Alternatively, process 2300 can include receiving a modulated reference signal, of the plurality of reference signals, in response to each of the at least one other TRPs transmitting a reference signal to the RIS. Process 2300 can include determining a location of a reconfigurable intelligent surface (RIS) based on one or more factors (block 2330). Examples of the factors can include a plurality of reference signals transmitted by the TRP and at least one other TRPs; a plurality of modulated reference signals from the RIS, where each modulated reference signal of the plurality of modulated reference signals is associated with a reference signal of the plurality of reference signals; and a location of the TRP and locations of the at least one other TRPs.

Examples and/or implementations herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, a transmission and reception point (TRP) can comprise a memory; and one or more processors configured to, when executing instructions stored in the memory, cause the TRP to: receive a reference signal from a transmitting TRP; receive a modulated reference signal from a reconfigurable intelligent surface (RIS), the modulated reference signal resulting from a modulation scheme applied to the reference signal of the transmitting TRP; and determine a location of the TRP based on a measurement of the reference signal, a location of the transmitting TRP, a measurement of the modulated reference signal, and a location of the RIS.

In example 2, which can also include one or more of the examples described herein, the TRP comprises at least one of: baseband circuitry, a user equipment (UE), or a base station.

In example 3, which can also include one or more of the examples described herein, the one or more processors are configured to cause the TRP to: determine the location of the TRP based further on a measurement of another modulated reference signal from another RIS and a location of the other RIS, the another modulated reference signal resulting from another modulation scheme applied to the reference signal of the transmitting TRP.

In example 4, which can also include one or more of the examples described herein, the one or more processors are configured to cause the TRP to: determine that the modulated signal is associated with the RIS based on the modulation scheme of the RIS; and determine that the another modulated signal is associated with the another RIS based on the another modulation scheme of the another RIS.

In example 5, which can also include one or more of the examples described herein, the one or more processors are configured to cause the TRP to: determine the location of TRP based further on a measurement of another reference signal from another transmitting TRP and a location of the another transmitting TRP.

In example 6, which can also include one or more of the examples described herein, the reference signal comprises a positioning reference signal (PRS), the modulated reference signal comprises a modulated PRS, and the location is determined based on a downlink (DL) time-difference-of-arrival (TDoA) of the reference signal and the modulated reference signal.

In example 7, which can also include one or more of the examples described herein, the reference signal comprises a sounding reference signal (SRS), the modulated reference signal comprises a modulated SRS, and the location is determined based on an uplink (UL) time-difference-of-arrival (TDoA) of the reference signal and the modulated reference signal.

In example 8, which can also include one or more of the examples described herein, the location is determined based on a round-trip time (RTT) procedure.

In example 9, which can also include one or more of the examples described herein, the reference signal comprises a comb-like pattern of resource elements (REs) and the modulate reference signal comprises the comb-like partner of REs shifted in a time domain or a frequency domain.

In example 10, which can also include one or more of the examples described herein, the reference signal comprises resource elements (REs) that are contiguous in a time domain and consistent in a frequency domain, and the modulate reference signal comprises REs that are contiguous in the time domain and inconsistent in a frequency domain.

In example 11, which can also include one or more of the examples described herein, the reference signal comprises a pattern of resource elements (REs) and the modulate reference signal comprises multiple REs for each of the REs of the reference signal.

In example 12, which can also include one or more of the examples described herein, the one or more processors further cause the TRP to: receive from the transmitting TRP: the location of the transmitting TRP, the location of the RIS, an indication of a pattern of resources elements (REs) associated with the reference signal, and an indication of the modulation scheme of the RIS.

In example 13, which can also include one or more of the examples described herein, a transmission and reception point (TRP) can comprise: a memory; and one or more processors configured to, when executing instructions stored in the memory, cause the TRP to: determine a location of a reconfigurable intelligent surface (RIS) based on: a plurality of reference signals transmitted by the TRP and at least one other TRPs; a plurality of modulated reference signals from the RIS, each modulated reference signal of the plurality of modulated reference signals being associated with a reference signal of the plurality of reference signals; and a location of the TRP and locations of the at least one other TRPs.

In example 14, which can also include one or more of the examples described herein, the TRP comprises a base station and each modulated reference signal, of the plurality of modulated reference signals, corresponds to a modulation scheme applied to a reference signal.

In example 15, which can also include one or more of the examples described herein, a reference signal of the TRP comprises a comb-like pattern of resource elements (REs) and the modulated reference signals comprises the comb-like pattern of REs shifted in a time domain or a frequency domain.

In example 16, which can also include one or more of the examples described herein, the one or more processors is configured to cause the TRP to: receive a modulated reference signal, of the plurality of reference signals, in response to transmitting a reference signal to the RIS.

In example 17, which can also include one or more of the examples described herein, the one or more processors is configured to cause the TRP to: receive a modulated reference signal, of the plurality of reference signals, in response to each of the at least one other TRPs transmitting a reference signal to the RIS.

In example 18, which can also include one or more of the examples described herein, the one or more processors is configured to cause the TRP to: determine the location of the RIS based a round-trip time (RTT) procedure corresponding to the plurality of reference signals and the plurality of modulated reference signals.

In example 19, which can also include one or more of the examples described herein, the one or more processors is configured to cause the TRP to: determine the location of the RIS based on: a time-difference-of-arrival (TDoA) procedure corresponding to the plurality of reference signals and the plurality of modulated reference signals; a distance between the TRP and the RIS; and distances between each TRP of the at least one TRPs and the RIS.

In example 20, which can also include one or more of the examples described herein, the distance between the TRP and the RIS, and the distances between each TRP of the at least one TRPs and the RIS, are determined by line-of-sight (LOS) measurements.

In example 21, which can also include one or more of the examples described herein, a method, performed by baseband circuitry can comprise: receiving a reference signal from a transmitting transmission and reception point (TRP); receiving a modulated reference signal from a reconfigurable intelligent surface (RIS), the modulated reference signal resulting from a modulation scheme applied to the reference signal of the transmitting TRP; and determining a location of the TRP based on a measurement of the reference signal, a location of the transmitting TRP, a measurement of the modulated reference signal, and a location of the RIS.

In example 22, which can also include one or more of the examples described herein, a method, performed by a UE, the method comprising: receiving a reference signal from a transmitting transmission and reception point (TRP); receiving a modulated reference signal from a reconfigurable intelligent surface (RIS), the modulated reference signal resulting from a modulation scheme applied to the reference signal of the transmitting TRP; and determining a location of the TRP based on a measurement of the reference signal, a location of the transmitting TRP, a measurement of the modulated reference signal, and a location of the RIS.

In example 23, which can also include one or more of the examples described herein, a method, performed by a base station, the method comprising: determining a location of a reconfigurable intelligent surface (RIS) based on: a plurality of reference signals transmitted by the TRP and at least one other TRPs; a plurality of modulated reference signals from the RIS, each modulated reference signal of the plurality of modulated reference signals being associated with a reference signal of the plurality of reference signals; and a location of the TRP and locations of the at least one other TRPs.

In example 24, which can also include one or more of the examples described herein, baseband circuitry can comprise a memory; and one or more processors configured to, when executing instructions stored in the memory, cause the TRP to: receive a reference signal from a transmitting TRP; receive a modulated reference signal from a reconfigurable intelligent surface (RIS), the modulated reference signal resulting from a modulation scheme applied to the reference signal of the transmitting TRP; and determine a location of the TRP based on a measurement of the reference signal, a location of the transmitting TRP, a measurement of the modulated reference signal, and a location of the RIS.

The examples discussed above also extend to method, computer-readable medium, and means-plus-function claims and implementations, an of which can include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A transmission and reception point (TRP), comprising:
a memory; and
one or more processors configured to, when executing instructions stored in the memory, cause the TRP to:
receive a reference signal from a transmitting TRP;
receive a modulated reference signal from a reconfigurable intelligent surface (RIS), the modulated reference signal resulting from a modulation scheme applied to the reference signal of the transmitting TRP; and
determine a location of the TRP based on a measurement of the reference signal, a location of the transmitting TRP, a measurement of the modulated reference signal, and a location of the RIS.

2. The TRP of claim 1, wherein the TRP comprises at least one of:
baseband circuitry,
a user equipment (UE), or
a base station.

3. The TRP of claim 1, wherein the one or more processors are configured to cause the TRP to:
determine the location of the TRP based further on a measurement of another modulated reference signal from another RIS and a location of the other RIS, the another modulated reference signal resulting from another modulation scheme applied to the reference signal of the transmitting TRP.

4. The TRP of claim 3, wherein the one or more processors are configured to cause the TRP to:
determine that the modulated signal is associated with the RIS based on the modulation scheme of the RIS; and
determine that the another modulated signal is associated with the another RIS based on the another modulation scheme of the another RIS.

5. The TRP of claim 1, wherein the one or more processors are configured to cause the TRP to:
determine the location of TRP based further on a measurement of another reference signal from another transmitting TRP and a location of the another transmitting TRP.

6. The TRP of claim 1, wherein:
the reference signal comprises a positioning reference signal (PRS),
the modulated reference signal comprises a modulated PRS, and
the location is determined based on a downlink (DL) time-difference-of-arrival (TDoA) of the reference signal and the modulated reference signal.

7. The TRP of claim 1, wherein:
the reference signal comprises a sounding reference signal (SRS),
the modulated reference signal comprises a modulated SRS, and
the location is determined based on an uplink (UL) time-difference-of-arrival (TDoA) of the reference signal and the modulated reference signal, or
the location is determined based on a round-trip time (RTT) procedure.

8. The TRP of claim 1, wherein the reference signal comprises a comb-like pattern of resource elements (REs) and the modulate reference signal comprises the comb-like partner of REs shifted in a time domain or a frequency domain.

9. The TRP of claim 1, wherein the reference signal comprises resource elements (REs) that are contiguous in a time domain and consistent in a frequency domain, and the modulate reference signal comprises REs that are contiguous in the time domain and inconsistent in a frequency domain.

10. The TRP of claim 1, wherein the reference signal comprises a pattern of resource elements (REs) and the modulate reference signal comprises multiple REs for each of the REs of the reference signal.

11. The TRP of claim 1, wherein the one or more processors further cause the TRP to:
receive from the transmitting TRP:
the location of the transmitting TRP,
the location of the RIS,
an indication of a pattern of resources elements (REs) associated with the reference signal, and
an indication of the modulation scheme of the RIS.

12. A transmission and reception point (TRP), comprising:
a memory; and
one or more processors configured to, when executing instructions stored in the memory, cause the TRP to:
determine a location of a reconfigurable intelligent surface (RIS) based on:
a plurality of reference signals transmitted by the TRP and at least one other TRPs;
a plurality of modulated reference signals from the RIS, each modulated reference signal of the plurality of modulated reference signals being associated with a reference signal of the plurality of reference signals; and
a location of the TRP and locations of the at least one other TRPs.

13. The TRP of claim 12, wherein the TRP comprises a base station and each modulated reference signal, of the plurality of modulated reference signals, corresponds to a modulation scheme applied to a reference signal.

14. The TRP of claim 12, wherein a reference signal of the TRP comprises a comb-like pattern of resource elements (REs) and the modulated reference signals comprises the comb-like pattern of REs shifted in a time domain or a frequency domain.

15. The TRP of claim 12, wherein the one or more processors is configured to cause the TRP to:
receive a modulated reference signal, of the plurality of reference signals, in response to transmitting a reference signal to the RIS.

16. The TRP of claim 12, wherein the one or more processors is configured to cause the TRP to:
receive a modulated reference signal, of the plurality of reference signals, in response to each of the at least one other TRPs transmitting a reference signal to the RIS.

17. The TRP of claim 16, wherein the one or more processors is configured to cause the TRP to:
determine the location of the RIS based a round-trip time (RTT) procedure corresponding to the plurality of reference signals and the plurality of modulated reference signals.

18. The TRP of claim 16, wherein the one or more processors is configured to cause the TRP to:
determine the location of the RIS based on:
a time-difference-of-arrival (TDoA) procedure corresponding to the plurality of reference signals and the plurality of modulated reference signals;
a distance between the TRP and the RIS; and
distances between each TRP of the at least one TRPs and the RIS.

19. The TRP of claim 18, wherein the distance between the TRP and the RIS, and the distances between each TRP of the at least one TRPs and the RIS, are determined by line-of-sight (LOS) measurements.

20. A method, performed by baseband circuitry, the method comprising:
receiving a reference signal from a transmitting transmission and reception point (TRP);
receiving a modulated reference signal from a reconfigurable intelligent surface (RIS), the modulated reference signal resulting from a modulation scheme applied to the reference signal of the transmitting TRP; and
determining a location of the TRP based on a measurement of the reference signal, a location of the transmitting TRP, a measurement of the modulated reference signal, and a location of the RIS.
